(19) United States
(12) Patent Application Publication
(10) Pub. No.: US 2006/0185462 A1
(43) Pub. Date: Aug. 24, 2006

(54) Tilt head rattle pivot pin noise reduction device for steering column assembly

(76) Inventors: David L. Berg, Auburn, MI (US); Eugene Thomas Tanke II, Vassar, MI (US)

Correspondence Address: DELPHI TECHNOLOGIES, INC., M/C 480-410-202, PO BOX 5052, TROY, MI, 48007, US

(21) Appl. No.: 11/343,327

(22) Filed: Jan. 31, 2006

Related U.S. Application Data
(60) Provisional application No. 60/655,184, filed on Feb. 22, 2005.

(51) Int. Cl. B62D 1/18

(52) U.S. Cl. 74/493; 280/775

(57) ABSTRACT

A steering column assembly for a motor vehicle having adjustable tilt including a tilt housing pivotally connected to a support housing on an upper end of a tubular column sleeve. Pivotal connection is accomplished through a pair of coaxially aligned fasteners extending along a horizontal tilt axis and positioned on opposite sides of a rotatable steering shaft carried inside the column sleeve. The fasteners are separately actionable to reversibly adjust their lengths and thereby create a tuned frictional engagement between the support housing and the tilt housing so that objectionable rattling noises in the column assembly can be attenuated.

### CROSS REFERENCE TO RELATED APPLICATIONS

This application claims to benefit of priority to U.S. Provisional Application No. 60/655,184 filed Feb. 22, 2005.

### FIELD OF THE INVENTION

The invention relates to a tiltable steering column for a vehicle, and more particularly toward an optimized pivoting connection between the tilt housing and an upper steering column sleeve to attenuate objectionable rattling noises.

### BACKGROUND OF THE INVENTION

Steering columns for motor vehicles can be made to tilt so that the driver is able to better position the steering wheel for maximum comfort. Objectionable rattling noises in the region of the tilt head portion of the steering column have been a vexing problem for many years. Various solutions to the problem have been proposed, but success has not been achieved to any acceptable degree.

For example, U.S. Pat. No. 6,851,331 to Kuroumaru et al, issued Feb. 8, 2005, depicts a tilt housing arrangement in which the lock lever is rotable about the axis of a supporting shaft. When the lock lever is rotated around the axis of the supporting shaft, a cam surface is rotated relative to the cam follower. As a result, the cam surface presses the cam follower against side plates of a fixed bracket to achieve tilt locking. A nut on the end of the threaded supporting shaft can be tightened to create a compression condition between the tilt housing and its associated support housing on the end of the steering column sleeve. Depending on how tightly this nut is adjusted, a favorable affect may be achieved with regard to the problem of objectionable rattling noises in the tilt housing region. One drawback, however, of this arrangement arises out of the use of a single supporting shaft and nut arrangement. Such an arrangement requires the tilt axis to be offset laterally from the longitudinal steering axis. Furthermore, the unitary support shaft and nut arrangement can be difficult to adjust from side to side and is subject to high loading stresses. And furthermore, the rattling noise can be made worse if the driver does not fully secure the locking lever.

Also known from production use are coaxially aligned fasteners arranged along the tilt axis on opposite sides of the steering shaft. The fasteners take the form of pivot pins which are pounded into place with a vibratory hammer device. Each pivot pin has a press fit in the support housing and a close tolerance slip fit in the tilt housing. The tilt housing and the support housing are free to move relative to each other via this arrangement. A compressive force between the tilt housing and the support housing may or may not be accomplished, depending on the angle the pivot pins are driven at, the force used to drive the pivot pins, the pivot pin size variation, the pivot hole size variation, and many other variables. These variables allow many columns to experience an objectionable rattling noise in the tilt head, and in some cases extra lash and varying amounts of tilt effort can be present.

Accordingly, there is a long felt yet unsatisfied need within the motor vehicle industry for a tilt adjustable steering column assembly configured so as to reduce or attenuate objectionable rattling noises in the tilt housing region.

### SUMMARY OF THE INVENTION AND ADVANTAGES

The subject invention provides a steering column assembly for a motor vehicle having an adjustable tilt. The assembly comprises a generally tubular column sleeve having a support housing disposed on an upper end thereof. A steering shaft is rotatably carried within the column sleeve about a longitudinal steering axis. A tilt housing pivotally connects to the support housing for articulating movement about a tilt axis generally perpendicular to the longitudinal steering axis. A pair of coaxially aligned fasteners extend along the tilt axis and interconnect the tilt housing to the support housing on opposite sides of the steering shaft. The fasteners are independently telescopically adjustable to establish a predetermined compression condition between the support housing and the tilt housing. Each of the fasteners have a respective first end in pressing contact with the support housing and a second end in pressing contact with the tilt housing. The fasteners are separately actionable to draw their respective first and second ends toward one another to establish a tuned frictional engagement between the support housing and the tilt housing, whereby objectionable rattling noises in the column assembly can be attenuated through the deliberate and independent manipulation of the fasteners to the predetermined compression condition.

According to another aspect of the invention, a method for attenuating objectionable rattling noises in a steering column assembly is provided for a motor vehicle having adjustable tilt. The method comprises the steps of providing a generally tubular column sleeve having a support housing disposed on an upper end thereof; providing a steering shaft; rotatably supporting the steering shaft within the column sleeve about a longitudinal axis; providing a tilt housing; and pivotally connecting the tilt housing to the support housing for articulating movement about a tilt axis generally perpendicular to the longitudinal steering axis. The step of pivotally connecting includes providing a pair of coaxially aligned fasteners extending along the tilt axis and spaced apart on opposite sides of the steering shaft. Each of the fasteners has a length. And the method further includes the step of independently telescopically adjusting the length of each fastener to establish a predetermined compression condition between the support housing and the tilt housing whereby objectionable rattling noises in the column assembly can be attenuated through the deliberate and independent manipulation of the fasteners to the predetermined compression condition.

The apparatus and method of the subject invention overcome the shortcoming and disadvantages characterizing the prior art teachings, by utilizing independently telescopically adjustable fasteners disposed on opposite sides of the steering shaft to pivotally connect the tilt housing to the support housing. And then, through the deliberate and independent manipulation of the fasteners, the predetermined compression condition can be achieved which reduces or eliminates tilt housing rattle, with potential side benefits of reducing lash in the steering column assembly and yielding consistent tilt efforts from one steering column assembly to the next when manufactured according to high volume production procedures.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a steering column assembly according to the subject invention;

FIG. 2 is a side view of the steering column assembly of FIG. 1;

FIG. 3 is a partial cross-sectional view taken generally along lines 3-3 of FIG. 2;

FIG. 4 is a cross-sectional view of a first alternative embodiment of the subject invention, the cross-section corresponding generally to FIG. 3;

FIG. 5 is a cross-sectional view of a second alternative embodiment of the invention, the cross-section corresponding generally to FIG. 3; and

FIG. 6 is a cross-sectional view of a third alternative embodiment of the invention, the cross-section corresponding to the cross-section shown in FIG. 3.

### DETAILED DESCRIPTION OF THE PREFERRED EMBODIMENT

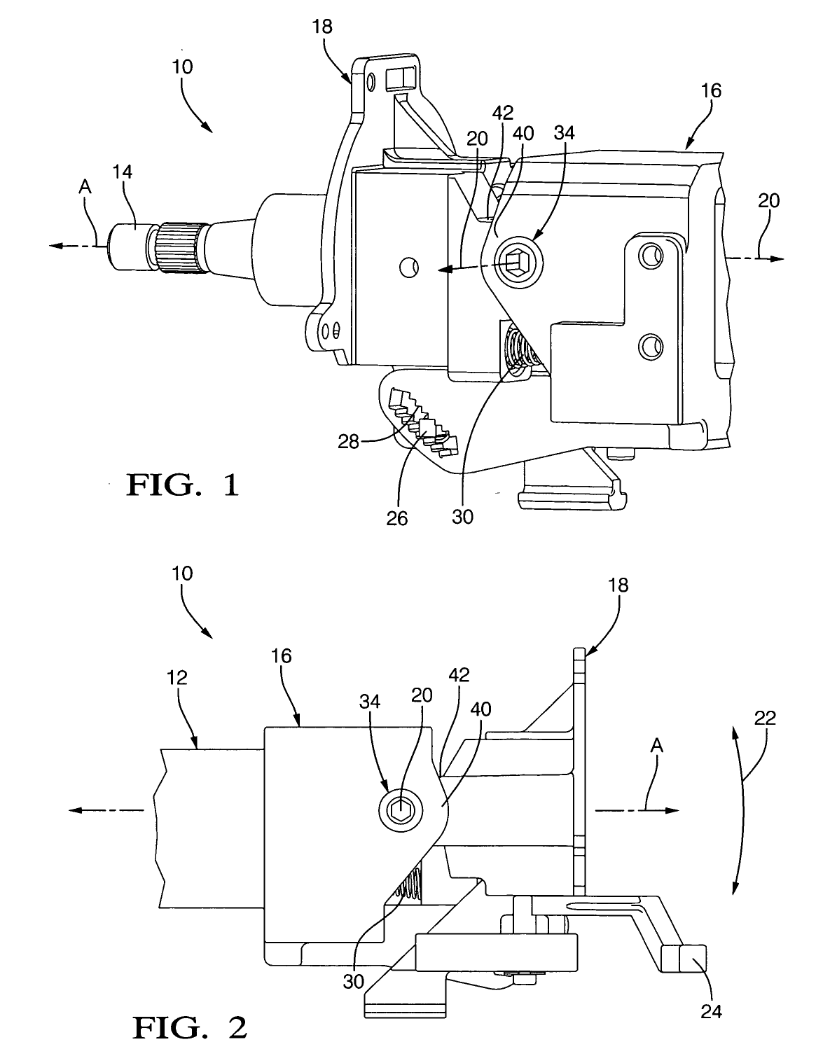

Referring to the Figures, wherein like numerals indicate like or corresponding parts throughout the several views, a steering column assembly for a motor vehicle having adjustable tilt is generally shown at 10 in FIGS. 1-3. The steering column assembly 10 is of the type commonly used in motor vehicles which includes a steering wheel (not shown) which can be adjusted by the driver for tilt, i.e., up and down, and optionally may be adjusted for reach, i.e., telescoping movement in and out. The assembly 10 includes the typical tubular column sleeve, generally indicated at 12 in FIG. 2. The column sleeve 12 carries an inner steering shaft 14 for rotation about a longitudinal steering axis A. An upper end of the steering shaft 14 is operatively connected to the steering wheel, and its lower end is connected through conventional mechanisms to the front wheels of the vehicle so that movements of the steering wheel can be transmitted to the front wheels through the inner rotating steering shaft 14.

As stated previously, the subject steering column assembly 10 is of the type having adjustable tilt, whereby the steering wheel can be pivoted up and down by the driver so as to orient the steering wheel in a comfortable driving position. To accomplish the tilt function, the column sleeve 12 is provided with a support housing 16 at its upper end. A complimentary tilt housing 18 pivotally connects to the support housing 16 for articulating movement about a tilt axis 20 which is generally perpendicular to the longitudinal steering axis A. As is commonly understood, the tilt axis 20 is predominantly horizontally oriented, and allows the steering wheel to move in a generally arcuate tilt path 22 as represented by the directional arrow in FIG. 2.

Any suitable form of tilt lock mechanism can be employed to selectively hold the tilt housing 18 in an adjusted position relative to the support housing 16. In the examples depicted in FIGS. 1 and 2, a mechanical system is shown including a manual tilt lock release lever 24 that can be actuated by the driver to manipulate a pawl 26 into and out of engagement with a toothed arcuate slot 28 as shown in FIG. 1. The curvature of the slot 28 is centered about the tilt axis 20 so that the pawl 26 moves together with the tilt housing 18 as a driver is adjusting the position of the steering wheel. Once a comfortable position has been achieved, the driver manipulates the tilt lock release lever 24 thereby reengaging the pawl 26 within the arcuate slot 28 and fixing the tilt housing 18 relative to the support housing 16. Those skilled in the art will readily appreciate the numerous alternative examples of tilt lock mechanisms, including such devices which may be controlled through the use of electric, pneumatic or hydraulic motors or the like. A counterbalance spring 30 is disposed between the tilt housing 18 and the support housing 16 as shown in FIGS. 1 and 2, to improve the operation of the tilting function. Of course, other spring or counterbalance mechanisms or approaches can be deployed to accomplish the same purpose.

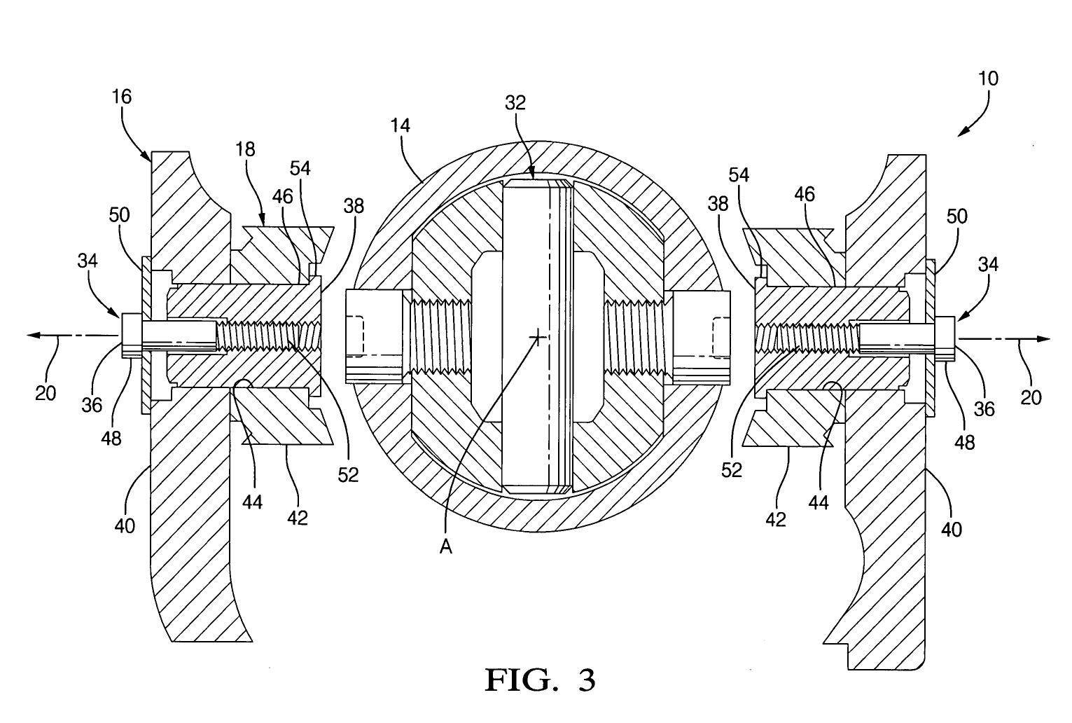

The steering shaft 14 includes a suitable universal joint 32 or other type of articulating or flexible joint in the region of the tilt axis 20 so as to accommodate angular displacement of the tilt housing 18 relative to the elongated column sleeve 12. Most typically, a cross-pin style universal joint, suitably lubricated, can be used for this purpose as illustrated in FIG. 3.

A particular object of the present invention is to address the problem of objectionable rattling noises emanating from the steering column assembly 10 in the region of the tilt housing 18. As described previously, the prior art has experienced a long felt, yet unsolved need for reducing rattling noises, and to a lesser extent lash, emanating from the articulating joint between the tilt housing 18 and the support housing 16. The subject invention addresses this concern, and overcomes the prior art shortcomings by utilizing a pair of co-axially aligned fasteners, generally indicated at 34, disposed along the tilt axis 20 and interconnecting the tilt housing 18 to the support housing 16 on opposite sides of the steering shaft 14. The fasteners 14 are uniquely constructed so as to be independently telescopically adjustable with the purpose of establishing, through their adjustable length, a predetermined compression condition between the support housing 16 and the tilt housing 18.

As perhaps best shown in FIG. 3, each fastener 34 has a first end 36 in pressing contact with the support housing 16 and a second end 38 in pressing contact with the tilt housing 18. Although the use of the terms “first end” and “second end” have been adopted arbitrarily, the arrangement described here and depicted in FIG. 3 arises out of the particular orientation of the support housing 16 relative to the tilt housing 18. Specifically, in the preferred embodiment of the invention, the support housing 16 is provided with outer sidewalls 40 which surround, or otherwise encase, a pair of arms 42 emanating from the tilt housing 18. In this configuration, the first end 36 of each fastener 34 comprises its outer, accessible end which abuts the outer sidewalls 40 of the support housing 16. The second end 38 of each fastener 34, by contrast, engages the inner region of arms 42 so that, when the length of the fastener 34 is reduced via its telescopically adjustable features, the arms 42 are drawn, respectively, against the outer sidewalls 40 of the support housing 16, creating a compression condition which results in friction along the surface-to-surface interfaces therebetween. Because the fasteners 34 are separately actionable to reversibly draw their respective first 36 and second 38 ends toward one another, it is possible to tune the frictional engagement between the support housing 16 and the tilt housing 18 to such a degree that the objectionable rattling noises in the column assembly 10 can be attenuated through this deliberate and independent manipulation of the fasteners 34 to achieve the predetermined compression condition.

Referring still to FIG. 3, the outer support walls 40 of the support housing 16 and the arms 42 of the tilt housing 18 are shown including coaxially aligned holes 44 formed along the tilt axis 20. The fasteners 34 are also provided with a bushing 46 having a generally cylindrical outer surface for simultaneously engaging the holes 44. The outer surface of the bushings 46 establish the bearing surfaces upon which the tilt housing 18 pivots about the tilt axis 20. Although many configurations of this bushing arrangement can be contemplated, it is preferred that the bushing 46 is pressed-fit, or interference fit, in the outer sidewalls 40 while provided with a clearance fit in the arms 42, so that the bushing 46 remains stationary relative to the support housing 16, while the tilt housing 18 pivots. In this configuration, the bushing 46 is integral with the second end 38 of the fastener 34.

The first end 36 of the fastener 34 comprises a threaded bolt having a head 48 backed by a washer 50 in pressing contact with the outer sidewall 40. A threaded shank 52 engages a corresponding threaded bore in the bushing 46 to establish the telescopically adjustable functionality. The tool engaging feature formed in the head 48 allows the threaded shank 52 to be turned, thereby either drawing or pushing the bushing 46 and increasing or decreasing the compression condition between the arms 42 and outer sidewalls 40. The applicant has determined that the predetermined compression condition between the support housing 16 and the tilt housing 18 can be established at approximately 20 lbs/ft² in the contacting surface interface so as to substantially reduce or even eliminate the rattling noise issue, and address the ancillary concerns of lash and tilt effort. It should be appreciated that the approximate predetermined compression will vary with various tilt system designs and is in no way limited to 20 lb/ft? The tool engaging feature on the first end 36 of the fastener 34 may comprise an allen wrench socket, wrench flats, or other hexagonal faceted surface. Alternatively, a star point, phillips point, or any other common or proprietary tool engaging feature may be employed.

In this embodiment, the bushing 46 is shown including a flange 54 for establishing a pressing contact with the respective arms 42. Thus, the fasteners 34 act between their respective flanges 54 and washers 50 to deliberately and independently manipulate their respective applications of compression upon the support housing 16 and tilt housing 18. The use of screw threads in the preferred embodiment of the fasteners 34 may be particularly advantageous in setting, or tuning, the frictional engagement between the support housing 16 and the tilt housing 18. For example, because screw threads can be reversed, it is possible that an assembly specification may call for torquing the respective fasteners 34 so as to achieve a compression condition which is in excess of the predetermined amount, suggested at 20 lbs/ft² in the preceding example. Thus, it may be desirable to initially establish the compression between the support housing 16 and the tilt housing 18 at say 30 lbs/ft², for example, and then immediately back off the screw mechanism until the predetermined compression condition of 20 lbs/ft² is achieved. Although this procedure is merely exemplary and may be omitted in actual practice of the subject invention, it nevertheless demonstrates a unique and particular advantage of the fasteners 34.

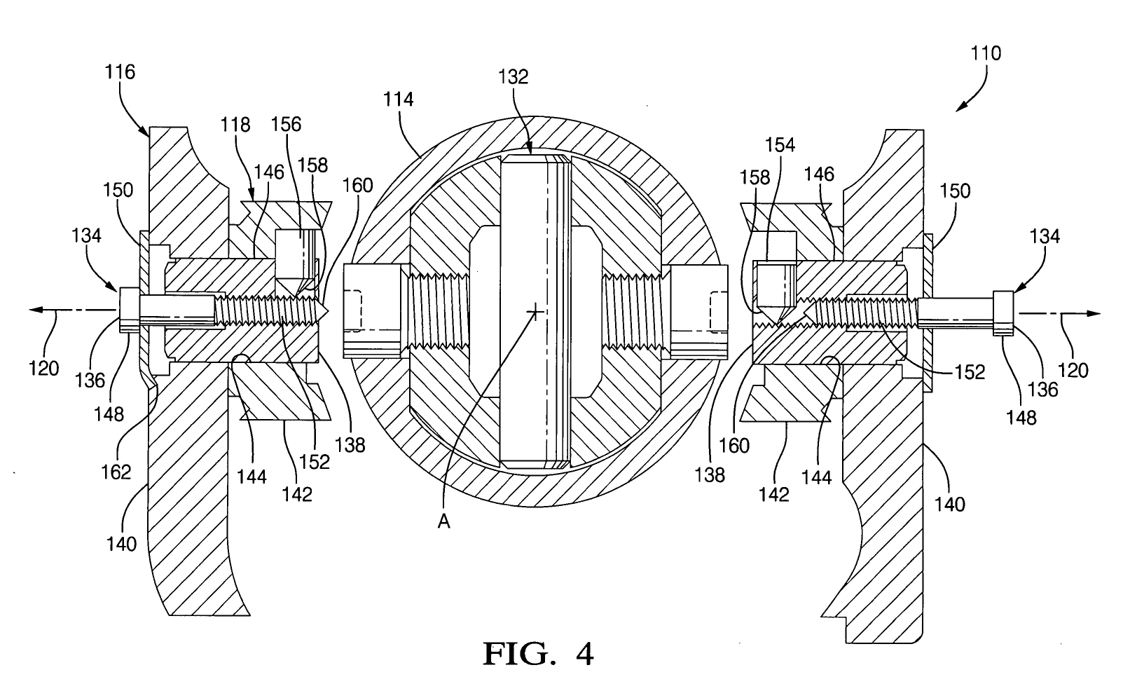

In FIG. 4, a first alternative embodiment of the subject invention is depicted in a view similar to that of FIG. 3. To facilitate understanding of the first alternative embodiment shown in FIG. 4, like components are identified with like reference numerals but preceded by the prefix “1”. Therefore, in this first alternative embodiment, a very similar construction is shown wherein the tilt housing 118 is shown including arms 142 pivotally connected to outer sidewalls 140 of the support housing 116 through their journaled engagement with the outer surface of bushing 146 as a component of the fasteners 134. This embodiment is particularly adapted for an expedient method of assembling the tilt housing 118 to the support housing 116 whereby the fasteners 134 can be loaded as an assembled unit from the exterior.

More specifically, the fasteners 134 are provided with an automatic, toggle-like feature to enable the bushing 146 to be inserted into the coaxially aligned holes 144 from the exterior side of the outer sidewalls 140. Here, the bushings 146 are shown including a toggle pin 156 arranged to slide in a radial fashion between a retracted loading condition shown on the right hand side of FIG. 4 and then extended to an operative position as shown on the left hand side in FIG. 4. Movement between the retracted and extended positions is accomplished through a cam surface 58 established on the inner end of the toggle pin 156. The cam surface 158 is engagable by a shaped tip 160 on the shank 152 so that as the bolt is advanced through the threaded bore of the bushing 146, the toggle pin 156 is forcibly extended to its operative position as shown on the left hand side of FIG. 4. By this action, the fasteners 134 can be easily installed into the coaxial holes 144 from the exterior and then automatically manipulated so as to achieve the deliberate and independent adjust described above and essential to the establishment of the predetermined compression condition between the support housing 116 and the tilt housing 118. Thus, the toggle pin 156 comprises an extensible member which is responsive to movement of the male threaded shank 52 in the female threaded bore in the bushing 146.

FIG. 4 illustrates yet another aspect of the invention which can be adapted for use in any of the embodiments described herein, or as may be contemplated by those skilled in the art when practicing the novel aspects of the subject invention. Particularly, the fasteners 134 are shown here including a means for resisting un-threading of the screw when the fastener 134 is in its predetermined compression condition. The means illustrated in this Figure comprises a crimp-like set 162 plastically deformed into the outer edge of the washer 150 and embedding itself in the surface of the outer sidewalls 40. The set 162 is preferably formed after the predetermined compression condition has been deliberately set. However, various configurations of the fasteners 134 may allow or require the set 162 to be introduced prior to achieving the predetermined compression condition. Another method for resisting un-threading of the screw when the fastener 134 is in its predetermined compression condition will be described in the following example.

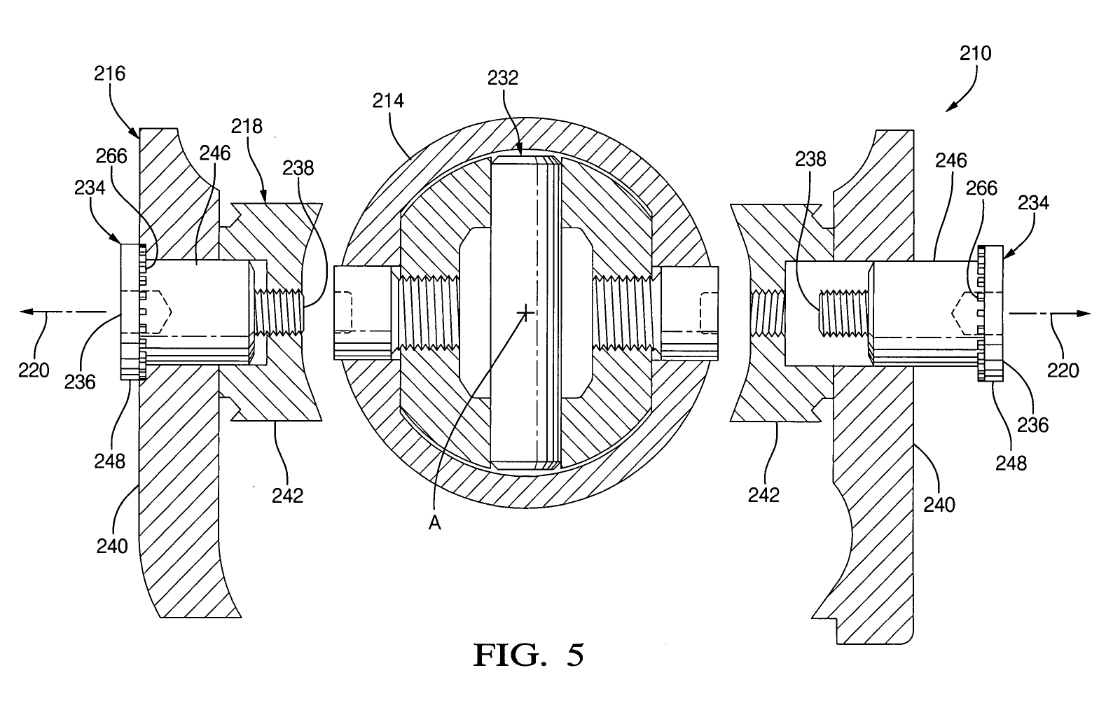

Referring now to FIG. 5, a second alternative embodiment of the invention is shown. This second alternative embodiment of the invention is illustrated using many components similar to those described in the preceding examples. Therefore, for convenience, like reference numerals will be employed on such similar components but the distinguishing prefix “2” will be used throughout this embodiment. Here, the fasteners 234 take a markedly different form than those of the preceding examples. Specifically, here the bushing 246 is integral with the first end 236 of the fasteners 234 and the second end 238 is provided with male screw threads 264. Also, the coaxial holes 244 are configured somewhat differently in this embodiment. While the portion of the hole 244 is again formed as a straight through-hole in the outer sidewalls 240, a stepped or counter-sunk configuration is formed into the arms 242 so as to accommodate female threads which compliment the male screw threads 264. A particular advantage of this second alternative embodiment resides in the ability to assemble the fasteners 234 from the exterior, accessible vantage through the outer sidewalls 240. Additionally, the fasteners 234 in this example comprise a single piece unit which may result in lower fabrication costs. Each fastener 234 is shown including an enlarged hex head 248 which bears in pressing contact against the exterior surface of the outer sidewalls 240. The under side of the head 248 can be knurled 266 so as to provide a means for resisting unthreading of the screws when the fastener 234 is in its predetermined compression condition. Of course, those skilled in the art will appreciate other techniques which could be introduced in addition to, or in lieu of, the knurls 266 to accomplish the desired goal of resisting unthreading of the screws once the predetermined compression condition has been achieved.

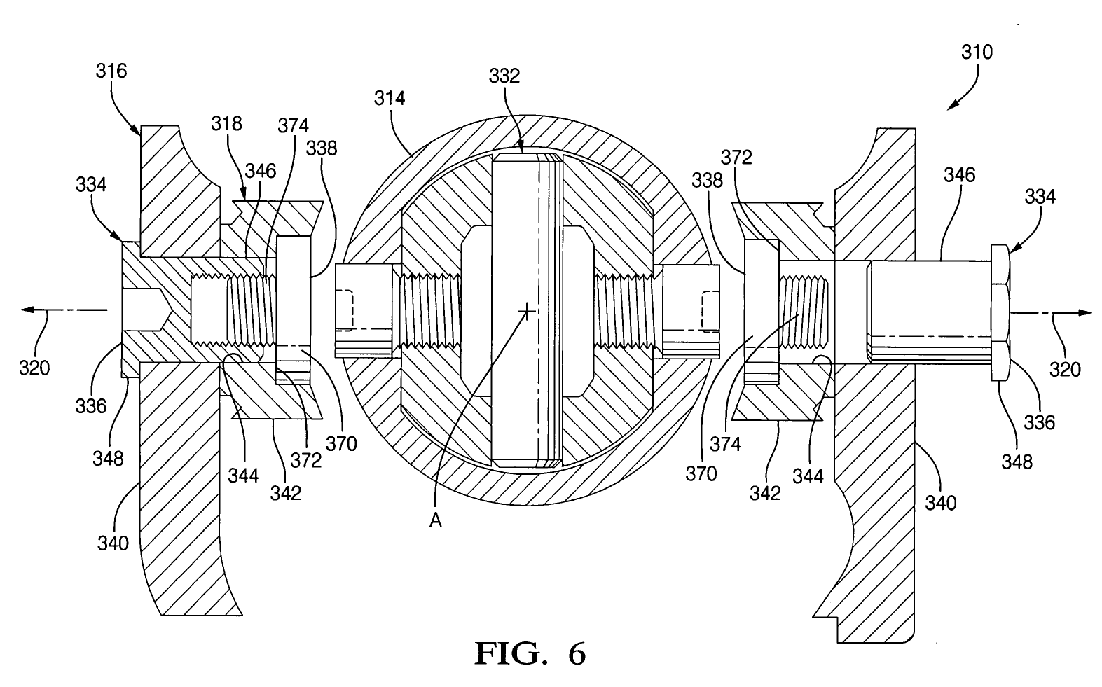

In FIG. 6, a third alternative embodiment is shown illustrating yet another variation within which to accomplish the articulating movement of the tilt housing 38 relative to the support housing 316. In this example, as in previous examples, like or corresponding parts are referenced with like numerals, but here include the prefix “3” for convenience. In this third alternative embodiment, the fasteners 334 are shown with the bushing portion 346 integral with the first end 336, as in the preceding example. However, the bushing 336 is formed with a female threaded pocket 368. The second end 338 of the fasteners 334 includes a sturdy flange 370 seated in an appropriate counter-bore 372 in each of the arms 342. Male threads 374 extend from the flange 370 and are adapted to engage the female threaded pocket 368 in the bushing 346. Preferably, the flange 370 is provided with splines, knurls, or other features to prevent rotation within the counter-bore 372 of the arm 342. Thus, as the bushing 346 is rotated through manipulation of its tool engaging feature, the male and female threads engage and cause the arms 342 to be drawn against their respective outer sidewalls 340 to achieve the predetermined compression condition.

All of the embodiments described above in connection with the subject invention provide but a limited number of examples for carrying out this novel method of attenuating objectionable rattling noises in a steering column assembly 10 for a motor vehicle having an adjustable tilt. These novel method steps include providing a generally tubular column sleeve 12 having a support housing 16 disposed on an upper end thereof. A steering shaft 14 is rotatably supported within the column sleeve 12 about a longitudinal steering axis A. A tilt housing 18 is pivotally connected to the support housing 16 for articulating movement about a tilt axis 20 which is generally perpendicular to the longitudinal steering axis A. The step of pivotally connecting includes providing a pair of coaxially aligned fasteners 34 extending along the tilt axis 20 and spaced apart on opposite sides of the steering shaft 14. Each of the fasteners 34 has a length. And the method is emphasized by the step of independently telescopically adjusting the length of each fastener 34 to establish a predetermined compression condition between the support housing 16 and the tilt housing 18 whereby the objectionable rattling noises in the column assembly 10 can be attenuated through the deliberate and independent manipulation of the fasteners 34 to their predetermined compression condition.

Further, perfecting steps of the subject method include independently telescopically adjusting the length of each fastener by turning a threaded first end 36 of the fastener 34. The method can be further enhanced by including the step of preventing unintentional turning of the first end 36 of each fastener 34 so as to maintain the predetermined compression condition once it is set. The applicant has found that the step of independently telescopically adjusting the length of each fastener 34 can be practiced successfully by creating approximately 20 lbs/ft² of surface-to-surface compression between the support housing 16 and the tilt housing 18.

While the invention has been described with reference to these exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best modes contemplated for carrying out this invention, but that the invention will include all embodiments falling within the scope of the appended claims.

What is claimed is:

1. A steering column assembly for a motor vehicle having adjustable tilt, said assembly comprising:
a generally tubular column sleeve having a support housing disposed on an upper end thereof,
a steering shaft rotatably carried within said column sleeve about a longitudinal steering axis;
a tilt housing pivotally connected to said support housing for articulating movement about a tilt axis generally perpendicular to said longitudinal steering axis;
a pair of co-axially aligned fasteners extending along said tilt axis and interconnecting said tilt housing to said support housing on opposite sides of said steering shaft, said fasteners independently telescopically adjustable to establish a predetermined compression condition between said support housing and said tilt housing;
each of said fasteners having a respective first end in pressing contact with said support housing and a second end in pressing contact with said tilt housing; and
said fasteners being separately actionable to draw said respective first and second ends toward one another to establish a tuned frictional engagement between said support housing and said tilt housing whereby objectionable rattling noises in said column assembly can be attenuated through the deliberate and independent manipulation of said fasteners to the predetermined compression condition.

2. The assembly of claim 1 wherein said fasteners include at least one screw thread.

3. The assembly of claim 1 wherein the predetermined compression condition between said support housing and said tilt housing is approximately 20 lb/ft².

4. The assembly of claim 1 wherein said first end of said fastener includes a tool engaging feature.

5. The assembly of claim 4 wherein said tool engaging feature includes a hexagonal faceted surface.

6. The assembly of claim 1 wherein each said fastener includes a bushing having a generally cylindrical outer surface for simultaneously engaging co-axially-aligned holes in said support housing and said tilt housing.

7. The assembly of claim 6 wherein said bushing is integral with said first end of said fastener.

8. The assembly of claim 6 wherein said bushing is integral with said second end of said fastener.

9. The assembly of claim 6 wherein said first end of said fastener includes a male threaded shank.

10. The assembly of claim 9 wherein said second end of said fastener includes a female threaded bore for receiving said male threaded shank.

11. The assembly of claim 10 wherein said second end of said fastener includes an extensible member responsive to movement of said male threaded shank in said female threaded bore.

12. The assembly of claim 9 wherein one of said tilt and support housings include a female threaded bore for receiving said male threaded shank.

13. The assembly of claim 6 wherein said first end of said fastener includes a female threaded bore and said second end of said fastener includes a male threaded shank for threadably engaging said female threaded bore.

14. The assembly of claim 1 wherein said fasteners include at least one screw thread, and further including a means for resisting un-threading of said screw when said fastener is in the predetermined compression condition.

15. A method for attenuating objectionable rattling noises in a steering column assembly for a motor vehicle having adjustable tilt, said method comprising the steps of:
providing a generally tubular column sleeve having a support housing disposed on an upper end thereof;
providing a steering shaft;
rotatably supporting the steering shaft within the column sleeve about a longitudinal steering axis;
providing a tilt housing;
pivotally connecting the tilt housing to the support housing for articulating movement about a tilt axis generally perpendicular to the longitudinal steering axis;
said step of pivotally connecting including providing a pair of co-axially aligned fasteners extending along the tilt axis and spaced apart on opposite sides of the steering shaft, each of the fasteners having a length; and
independently telescopically adjusting the length of each fastener to establish a predetermined compression condition between the support housing and the tilt housing whereby objectionable rattling noises in the column assembly can be attenuated through the deliberate and independent manipulation of the fasteners to the predetermined compression condition.

16. The method of claim 15 wherein said step of independently telescopically adjusting the length of each fastener includes turning a threaded first end of each fastener.

17. The method of claim 16 further including the step of preventing unintentional turning of the first end of each fastener to maintain the predetermined compression condition.

18. The method of claim 15 wherein said step of independently telescopically adjusting the length of each fastener includes creating approximately 20 lb/ft² of surface-to-surface compression between the support housing and the tilt housing.
